(19) United States
(12) Patent Application Publication
(10) Pub. No.: US 2019/0182713 A1
(43) Pub. Date: Jun. 13, 2019

(54) Dual Connectivity Enhancement for Content Caching Interworking

(71) Applicant: Nokia Technologies Oy, Espoo (FI)

(72) Inventors: Srinivasan Selvaganapathy, Bangalore (IN); Xiang Xu, Nanjing, Jiangsu (CN); Tsunehiko Chiba, Saitama (JP)

(21) Appl. No.: 16/324,665

(22) PCT Filed: Jul. 31, 2017
(86) PCT No.: PCT/IB2017/054673

§ 371 Date: Feb. 11, 2019

(30) Foreign Application Priority Data
Aug. 12, 2016 (IN) 201641027726

(51) Int. Cl. H04W 28/14; H04L 29/08

(52) U.S. Cl. CPC H04W 28/14; H04W 88/16; H04L 67/2842

(57) ABSTRACT

Disclosed is a method in a mobile network providing dual connectivity with local caching at access point. The method comprises a master access node (MeNB) and a secondary access node (SeNB). The master access node and the secondary access node exchange cache capability and cache content information based on which the master access node configures a secondary cell group bearer. Packets received at the secondary access node comprising a request for cacheable content are forwarded to the master access node for content retrieval if the content is not available at the local cache of the secondary access node. Other packets are forwarded directly to a serving gateway. The invention relates also to an apparatus, a computer program product and a non-transitory computer-readable medium.

### CROSS-REFERENCE TO RELATED APPLICATION

This application is related to and claims the benefit and priority of Indian Patent Application No. 201641027726, filed Aug. 12, 2016, the entirety of which is hereby incorporated herein by reference.

### BACKGROUND

### Field

Various communication systems may benefit from appropriate content caching. For example, certain wireless communication systems may benefit from a dual connectivity enhancement for content caching interworking.

### Description of the Related Art

In third generation partnership project (3GPP), long term evolution (LTE) dual connectivity feature was standardized in release 12 (Rel-12) and release 13(Rel-13). With this feature, a user equipment (UE) can be served by two base stations connected via non-ideal backhaul. Dual connectivity improves per user throughput and reliability of radio resource control (RRC) signaling for deployments where macro evolved Node Bs (eNBs) provide coverage layers and small-cells are used for capacity improvements as hot-spots. Fifth generation (5G) discussion has also started in 3GPP release 14 (Rel-14), and LTE-5G (new radio (NR)) interworking may use dual connectivity as well.

Each eNB may have an additional component in the user-plane-path which is capable of caching popular contents so that any access to the popular contents can be delivered from this node itself avoiding backhaul delay for these contents.

LTE Dual connectivity architecture is illustrated in FIGS. 1 and 2. More details are specified in 3GPP technical specification (TS) 36.300 and 3GPP TS 36.423.

FIG. 1 illustrates c-plane connectivity of eNBs involved in dual connectivity. As shown in FIG. 1 a mobile management entity (MME) can be connected to a macro eNB (MeNB) over interface S1-MME. The MeNB can be connected to a secondary eNB (SeNB) over interface X2-C.

FIG. 2 illustrates u-plane connectivity of eNBs involved in dual connectivity. As shown in FIG. 2 a serving gateway (S-GW) can be connected to an MeNB and an SeNB over respective S1-U interfaces. The MeNB and SeNB can be connected to each other over an X2-U interface.

If the content caching is enabled in the network, it is possible that it can be enabled in SeNB alone or both SeNB and MeNB. When UE is dual connectivity capable, it can be served by MeNB and SeNB. If both MeNB and SeNB have local cache for content caching, the secondary cell group (SCG) bearer establishment may need to be enhanced to allow sync up of contents between MeNB and SeNB caches. The SCG bearer is a bearer between S-GW and SeNB.

### SUMMARY

According to a first embodiment, a method can include exchanging, at a secondary access node, a cache capability with a master access node. The method can also include determining cache content information of the secondary access node. The method can further include exchanging the cache content information with the master access node.

According to a second embodiment, a method can include exchanging, at a master access node, a cache capability with a secondary access node. The method can also include exchanging, at the master access node, cache content information with the secondary access node to the master access node. The method can further include configuring a bearer type for a secondary cell group based on the cache capability and the cache content information.

According to certain embodiments, an apparatus can include at least one processor and at least one memory including computer program code. The at least one memory and the computer program code can be configured to, with the at least one processor, cause the apparatus at least to perform the method according to the first or second embodiment.

In certain embodiments, an apparatus can include means for performing the method according to the first or second embodiment.

A computer program product, according to certain embodiments, can encode instructions for performing a process. The process can include the method according to the first or second embodiment.

A non-transitory computer-readable medium, in certain embodiments, can be encoded with instructions that, when executed in hardware, perform a process. The process can include the method according to the first or second embodiment.

### BRIEF DESCRIPTION OF THE DRAWINGS

For proper understanding of the invention, reference should be made to the accompanying drawings, wherein:

FIG. 1 illustrates c-plane connectivity of eNBs involved in dual connectivity.

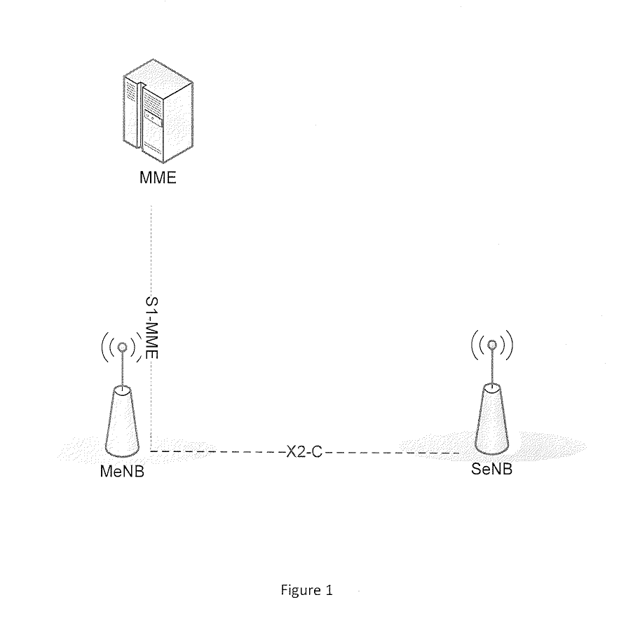

FIG. 2 illustrates u-plane connectivity of eNBs involved in dual connectivity.

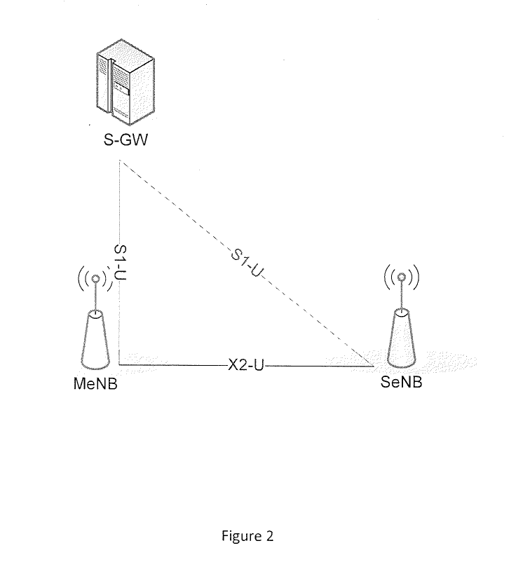

FIG. 3 illustrates a message sequence chart according to certain embodiments.

FIG. 4 illustrates uplink data-flow for SCG bearer with dynamic packet forwarding, according to certain embodiments.

FIG. 5 illustrates a method according to certain embodiments.

FIG. 6 illustrates a system according to certain embodiments.

### DETAILED DESCRIPTION

Certain embodiments provide mechanisms for interworking of content caching for dual connectivity deployments. When a user equipment (UE) enters an SeNB coverage area, the UE can be reconfigured to dual connectivity operation in which the UE is served by two cell groups: master cell group (MCG) controlled by MeNB and secondary cell group (SCG) controlled by SeNB. In normal deployments, when SeNB is added as SCG, the bearers can be moved to SeNB based on the throughput requirement and quality of service (QoS) parameters of the bearers. When the bearers are moved to SeNB, the issue of whether the bearers are configured as split bearers or SCG bearers can also be decided based on QoS attributes and loading condition, and so on, at each node. This is what the MeNB can do while adding SeNB to UE connection.

In deployments where each SeNB has a local cache available, when these SeNBs are added to UE connection, the bearer can be passed through the local cache of SeNB in order to have the enhancements of content aware delivery. This may require the MeNB to configure the bearer as an SCG bearer when SeNB is added. If a split bearer is configured, the packet data convergence protocol (PDCP) packets may not be able to be inspected at local cache at the SeNB.

According to certain embodiments, awareness of presence of local cache, for example at an SeNB, can be provided to the MeNB so that the MeNB can decide the right bearer-type. This notification regarding the local cache can be achieved by, for example, introducing an additional parameter in X2 interface messages.

If the deployments also have an MeNB local cache, after an SeNB is added to a UE, whenever the requested content as per the uplink packets is not available in SeNB cache, the uplink packets can be routed to the MeNB-cache to obtain the cache contents from MeNB itself instead of from an external server. For example, the uplink packets requesting the cached content can be routed to the MeNB, the MeNB cache can analyze the content and provide the content if the MeNB cache has the same. In case the MeNB cache does not have the requested content, the MeNB can forward the request to the SGW.

To achieve cache sync-up between the MeNB and the SeNB, whenever an SeNB is added to the UE connection, the bearers can be created in such a way that the user-plane packets of the SCG bearer are routed via MeNB to the SGW. The user-plane packets can be, for example, general packet radio service (GPRS) tunneling protocol (GTP) packets.

For dual connectivity operation with MeNB and SeNB having local cache, the new bearer configuration of SCG bearer can be terminated in SeNB with packets to SGW forwarded via MeNB. This option may have an advantage in that no S1 signaling is required when the UE moves out of the SeNB and SCG bearer is released. If the SeNB is provided with both options for packet forwarding and direct SGW path, the SeNB can select based on the analysis of the received uplink packet.

In certain embodiments, if both the MeNB and the SeNB have local cache capability, the MeNB can configure the SCG bearer to the SeNB in such a way that the GTP packets to the SGW can be forwarded via the MeNB. This forwarding mechanism can in turn enable the update of the SeNB cache from the MeNB cache.

For deployment with MeNB and SeNB having local cache, the MeNB can also configure the SCG bearer with two tunnel endpoint identifier (TEID) endpoints for uplink packets. One TEID endpoint can belong to the SGW and the other one can belong to the MeNB. If the uplink packet request is meant for content which is cacheable (such as a request for a specific URL or the like) the SeNB can forward the packet to the MeNB if the requested content is not present in the SeNB-cache. If the uplink packets are not related to requesting cached content, SeNB can send the packet directly to SGW avoiding the forwarding via MeNB.

The decision of selecting the SCG bearer with GTP forwarding via the MeNB can also be based on the status of a local cache at the MeNB and the SeNB instead of capability alone. For example, if there is more cache content in the SeNB than the MeNB, the benefit of forwarding the user plane packets to the MeNB may be minimal. In this case, the SCG bearer can be created without forwarding to avoid additional load on X2 link. If the MeNB cache content is reset, some UE(s) which are in dual connectivity can be reconfigured to use split bearer so that MeNB cache also can be synchronized, and thus the cache at the MeNB can be (re)built.

According to certain embodiments, additional information related to the SeNB-cache contents can be exchanged with the MeNB as part of existing SeNB addition or SeNB release procedures. Based on the additional information, the MeNB can decide for SCG bearer whether option for forwarding only or also option for forwarding and direct SGW path is to be enabled. The additional information can be status of content cache and/or load of content cache at the secondary node.

Certain embodiments relate to a method to indicate the SeNB cache capability as a static parameter through common X2 interface messages and dynamic status of cache contents via UE specific messages, such as SeNB addition and SeNB release.

The SeNB can indicate cache content information in X2 messages or a flow control message, for example in a GTP header. The MeNB decision as to selecting SCG bearer or SCG bearer with GTP forwarding via X2 or split bearer, can be based on SeNB-cache content and MeNB-cache content.

The MeNB can provide two GTP tunnel end points (MeNB and S-GW) to the SeNB based on content cache information. The SeNB-cache can select the path based on analysis of the packet.

Certain embodiments can be applied to LTE-5G, New Radio (NR), interworking. For example, certain embodiments can be applied for LTE-NR interworking scenarios where NR and LTE have content caching. To achieve ultra-low latency for content caching scenarios, it may be useful to sync up with the closest content cache through the user plane packet flow itself.

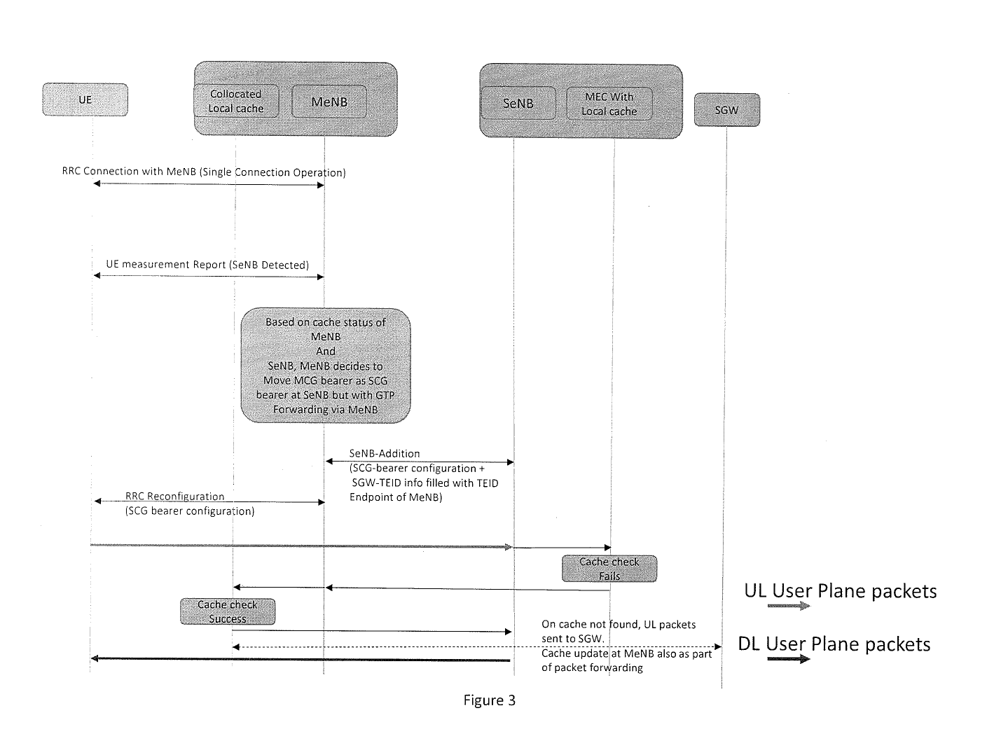

FIG. 3 illustrates a message sequence chart according to certain embodiments. The message sequence chart illustrates a possible realization of SeNB-addition in deployment where both MeNB and SeNB have local cache.

In order to assist the MeNB to take the right decision for bearer configuration, the SeNB can update the SeNB's local cache capability and also the status information via X2 messages or a user-plane mechanism such as flow control. This information exchange is not shown in the message sequence diagram of FIG. 3.

The SCG configuration can also provide two TEID endpoints for SCG bearers: one for the MeNB and another for an SGW. The SeNB can decide uplink packet forwarding based on whether the uplink packet is related to cacheable content.

If an uplink packet is analyzed to be meant for a different purpose than request for cacheable content, the SeNB can send packets to the SGW TEID endpoint. However, if the uplink packet is analyzed to be meant for cacheable content, then a local cache can be checked first and if the requested content is not available, then the packets can be forwarded to the MeNB.

With modified SCG bearer configuration, the uplink packets for which content in local cache is missing can be forwarded to the MeNB and the MeNB-local-cache. With this mechanism, if the requested content is present in MeNB-local-cache, the requested content can be delivered instead of forwarding the request to the SGW. This layered cache access can further enhance the content delivery performance of SeNB.

With the additional configuration of an option to select MeNB path or SGW path to SeNB, only uplink packets relevant for content caching may be forwarded via MeNB. Otherwise the packets can be sent to SGW.

This mechanism can provide efficient utilization of the MeNB-cache to provide better content delivery performance to a dual connectivity UE.

Uplink data flow for SCG bearer configuration can, in certain embodiments, be provided via network elements for content-cache-arch.

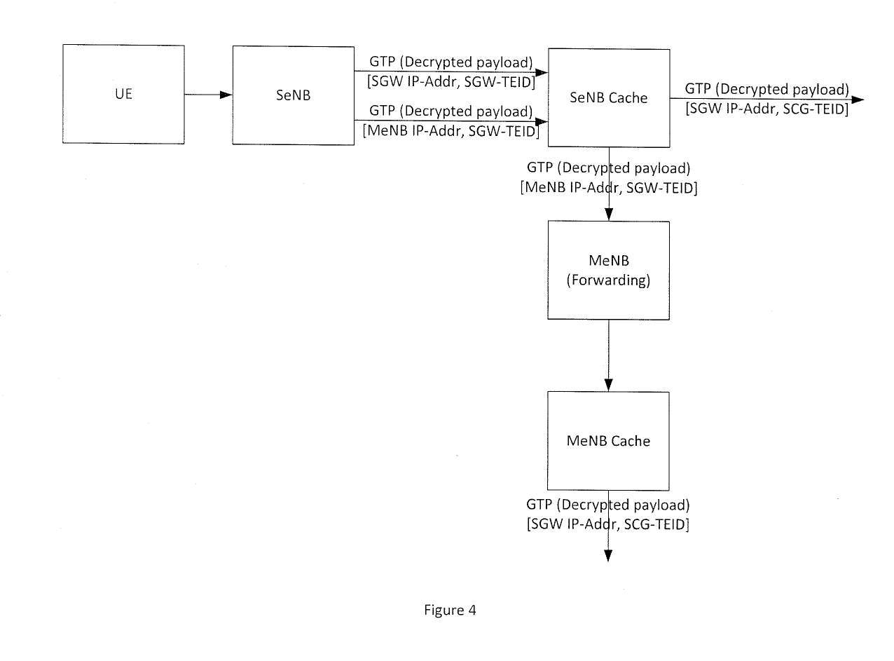

FIG. 4 illustrates uplink data-flow for SCG bearer with dynamic packet forwarding, according to certain embodiments. The SeNB can check packet content and can decide the GTP TEID endpoints. If the packet content is a request for cacheable content, the SeNB can select the MeNB-TEID. If the packet content is some other packet, the SeNB can select the SGW-TEID.

The SeNB cache can check for matching content. If available, DL packets can be generated from the SeNB cache. Likewise, the MeNB cache can check for matching content and, if available, DL packets can be generated from the MeNB cache.

In the process shown in FIG. 4, the following can occur. First, the UE can be configured with SCG bearer. Thus, the UE may always send the packets for this bearer to the SeNB. The UE can use a key, S-KeNB, for ciphering the packets at PDCP layer. The UE can send encrypted packet to the SeNB. The SeNB can then decrypt the packet and analyze whether the packet is related to a request for cacheable content. If it is determined that the packet is related to a request for cacheable content, the SeNB can fill the TEID of the MeNB and can send out the GTP packet via the SeNB's external interface, or port.

The IP packet, before reaching the external interface, can first reach the SeNB-cache in the path. The SeNB-cache can analyze and check whether the requested content is available in local cache. If the requested content is not available in the local cache, the SeNB-cache can continue to route the packet via the SeNB's external interface.

As the destination Internet protocol (IP) address is that of the MeNB, the packet can reach the MeNB, and the MeNB can now replace the Destination-IP with that of the SGW and can send the packet out via the MeNB's external interface. This may be just one implementation. Alternatively, the MeNB may first forward the request to the local cache. If the requested content is not in the local cache, the MeNB can add the destination IP of the SGW, or this may be an implementation issue when the cache is collocated with the MeNB. It is possible, in certain embodiments, for the MeNB to internally handle the forwarding and cache check.

The MeNB cache present in the path between the MeNB and the SGW can then receive the packet and analyze the content of the packet. If content of the packet is available, the MeNB cache can send a downlink GTP packet generated from stored content to SeNB.

This packet again can first reach SeNB-cache, which is the path towards the SeNB and the content can be updated in the SeNB-cache. The SeNB-cache can send out a DL packet to the SeNB. The SeNB can receive the DL GTP packet as if it were received from the SGW, can encrypt the packet using PDCP, and can deliver the packet to the UE.

In the process described above, because certain embodiments introduce a new bearer configuration with two tunnels, the SeNB can decide the endpoints based on packet type. For uplink packets corresponding to a request for cacheable content, the packet can go via SeNB-cache, MeNB, and MeNB-cache to allow faster sync up of the MeNB-cache. For other packet types, packets can go to the SGW directly from the SeNB-cache.

Although in FIG. 4 the SeNB and SeNB cache are shown as separate blocks, these blocks may be implemented in single physical device. Similarly, although the MeNB and MeNB cache are shown as separate blocks, these blocks may be implemented in single physical device.

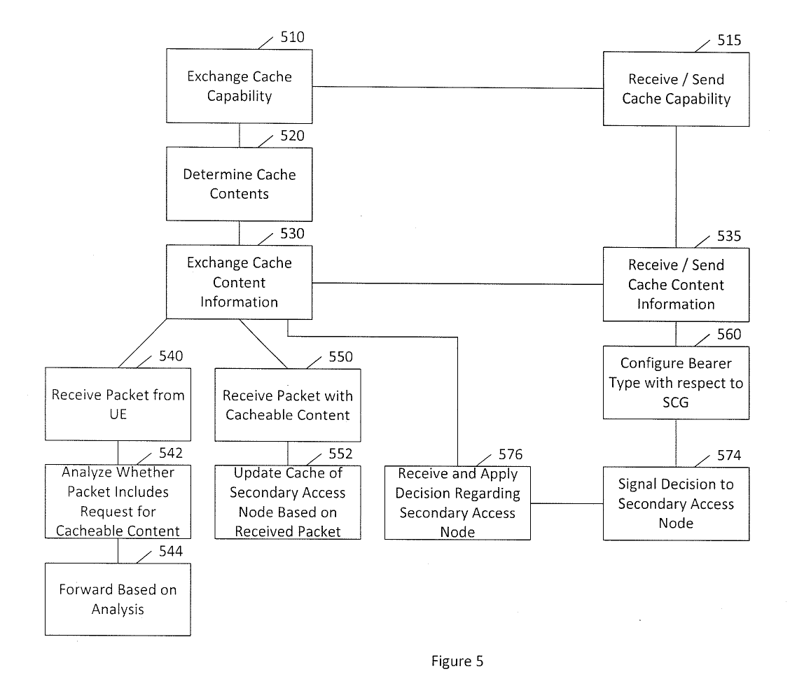

FIG. 5 illustrates a method according to certain embodiments. As shown in FIG. 5, a method can include, at 510, exchanging, at a secondary access node, a cache capability with a master access node. The exchanging can include indicating a cache capability of a secondary access node to a master access node. The exchanging can also include receiving a cache capability of a master access node at a secondary access node. The secondary access node may be, for example, an SeNB. The master access node may be, for example, an MeNB. The cache capability can be received/sent at the master access node, at 515. The cache capability can be indicated as a static parameter. Moreover, the cache capability can be indicated via a common X2 interface message.

The method can also include, at 520, determining cache content information of the secondary access node. The method can further include, at 530, exchanging the cache content information with the master access node. The exchanging the cache content information with the master access node can including indicating the cache content information to the master access node. The exchanging can also include receiving cache content information from the master access node. This cache content information can be received/sent by the master access node at 535.

The cache content can be indicated in dynamic status information. Moreover, the cache content can be indicated via a user equipment specific message. The user equipment specific message can include a secondary evolved node B addition message or a secondary evolved node B modification message or a secondary evolved node B release message, or any other user equipment specific message. The cache content can be indicated via an X2 message or a flow control message.

The method can further include, at 540, receiving a packet from a user equipment. The method can additionally include, at 542, analyzing whether the packet comprise a request for cacheable content. The method can further include, at 544, selecting between forwarding the packet to the master access node and directly communicating the packet to a serving gateway based on the analysis.

The packet can be received encrypted from the user equipment. Thus, the analyzing can involve decrypting the packet and evaluating the contents of the packet. The packet that is forwarded or directly communicated can have a decrypted payload, as illustrated in FIG. 4.

The method can additionally include, at 550, receiving a packet containing cacheable content from a master access node or a serving gateway. The method can also include, at 552, updating a cache of the secondary access node based on the received packet.

The method can further include, upon receiving, at a master access node at 515, a cache capability of a secondary access node and upon receiving, at the master access node at 535, cache content information of the secondary access node to the master access node, at 560 configuring a bearer type for a secondary cell group based on the cache capability and the cache content information. Configuring the bearer type can include selecting at least one of a secondary cell group bearer, a secondary cell group bearer with forwarding via X2, or a split bearer. The forwarding can be general packet radio service tunneling protocol forwarding.

The method can also include receiving additional information related to contents of the cache of the secondary access node. The additional information can be the status of content cache and/or load of content cache at secondary node. This additional information may be sent from the secondary access node. The method can further include deciding whether the secondary access node is to be permitted to use secondary cell group bearer only forwarding or to have an option between forwarding and a direct serving gateway path. This decision can then be signaled to the secondary access node at 574, and can be received and applied by the secondary access node at 576.

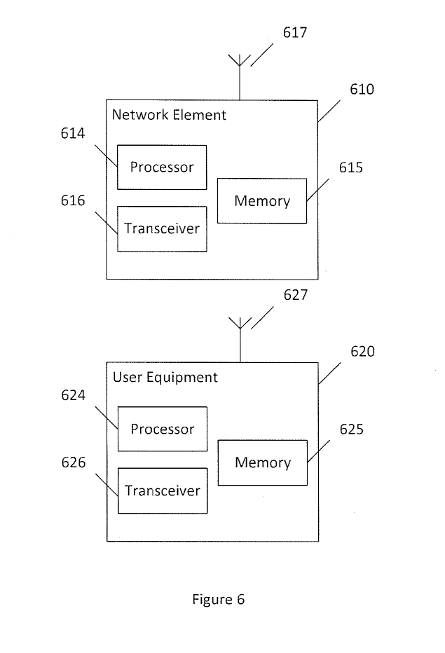

FIG. 6 illustrates a system according to certain embodiments of the invention. It should be understood that each block of the flowchart of FIG. 5 may be implemented by various means or their combinations, such as hardware, software, firmware, one or more processors and/or circuitry. In one embodiment, a system may include several devices, such as, for example, network element 610 and user equipment (UE) or user device 620. The system may include more than one UE 620 and more than one network element 610, although only one of each is shown for the purposes of illustration. A network element can be an access point, a base station, an eNode B (eNB), or any other network element, such as an MeNB or an SeNB.

Each of these devices may include at least one processor or control unit or module, respectively indicated as 614 and 624. At least one memory may be provided in each device, and indicated as 615 and 625, respectively. The memory may include computer program instructions or computer code contained therein, for example for carrying out the embodiments described above. The memory may also be configured to serve as a local cache, or a separate local cache memory may be provided. One or more transceiver 616 and 626 may be provided, and each device may also include an antenna, respectively illustrated as 617 and 627. Although only one antenna each is shown, many antennas and multiple antenna elements may be provided to each of the devices. Other configurations of these devices, for example, may be provided. For example, network element 610 and UE 620 may be additionally configured for wired communication, in addition to wireless communication, and in such a case antennas 617 and 627 may illustrate any form of communication hardware, without being limited to merely an antenna.

Transceivers 616 and 626 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 620 may be a mobile station (MS) such as a mobile phone or smart phone or multimedia device, a computer, such as a tablet, provided with wireless communication capabilities, personal data or digital assistant (PDA) provided with wireless communication capabilities, portable media player, a wearable device, a vehicle, a digital camera, a pocket video camera, a navigation unit provided with wireless communication capabilities or any combinations thereof. The user device or user equipment 620 may be a sensor or smart meter, or other device that may usually be configured for a single location.

In an exemplifying embodiment, an apparatus, such as a node or user device, may include means for carrying out embodiments described above in relation to FIG. 5.

Processors 614 and 624 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or units of at least one chip set (e.g., procedures, functions, and so on). Memories 615 and 625 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 610 and/or UE 620, to perform any of the processes described above (see, for example, FIG. 5). Therefore, in certain embodiments, a non-transitory computer-readable medium may be encoded with computer instructions or one or more computer program (such as added or updated software routine, applet or macro) that, when executed in hardware, may perform a process such as one of the processes described herein.

Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 6 illustrates a system including a network element 610 and a UE 620, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### List of Abbreviations

DC Dual connectivity

eNB evolved Node-N

RRC Radio Resource connection

MCG Master Cell Group

MeNB Master eNB

NR New RAT (new Radio)

RAT Radio Access Technology

SeNB Secondary eNB

SCG Secondary Cell Group

1-24. (canceled)

25. An apparatus, comprising:
at least one processor; and
at least one memory including computer program code,
wherein the at least one memory and the computer program code are configured to, with the at least one processor, cause the apparatus at least to
exchange, at a secondary access node, a cache capability with a master access node;
determine cache content information of the secondary access node; and
exchange the cache content information with the master access node.

26. The apparatus of claim 25, when exchanging the cache capability, the at least one memory and the computer program code are configured to, with the at least one processor, cause the apparatus to indicate the cache capability as a static parameter.

27. The apparatus of claim 25, wherein the exchange of the cache capability is performed via an X2 interface message.

28. The apparatus of claim 25, when exchanging the cache content information, the at least one memory and the computer program code are configured to, with the at least one processor, cause the apparatus to indicate dynamic status information.

29. The apparatus of claim 25, wherein the exchange of the cache content information is performed via a user equipment specific message, an X2 message or a flow control message.

30. The apparatus of claim 29, wherein the user equipment specific message comprises a secondary evolved node B addition message or a secondary evolved node B modification message or a secondary evolved node B release message, or any other user equipment specific message.

31. The apparatus of claim 25, wherein the at least one memory and the computer program code are configured to, with the at least one processor, cause the apparatus further to:
receive a packet from a user equipment;
analyze the packet; and
select between forwarding the packet to the master access node and directly communicating the packet to a serving gateway based on the analysis.

32. The apparatus of claim 31, when analyzing the packet, the at least one memory and the computer program code are configured to, with the at least one processor, cause the apparatus to analyze whether the packet comprises a request for cacheable content.

33. The apparatus of claim 25, the at least one memory and the computer program code are configured to, with the at least one processor, cause the apparatus further to:
receive a packet containing cacheable content from a master access node or a serving gateway; and
update a cache of the secondary access node based on the received packet.

34. An apparatus, comprising:
at least one processor; and
at least one memory including computer program code,
wherein the at least one memory and the computer program code are configured to, with the at least one processor, cause the apparatus at least to
exchange, at a master access node, a cache capability with a secondary access node;
exchange, at the master access node, cache content information with the secondary access node; and
configure a bearer type for a secondary cell group based on the cache capability and the cache content information.

35. The apparatus of claim 34, when configuring the bearer, the at least one memory and the computer program code are configured to, with the at least one processor, cause the apparatus to configure at least one of a secondary cell group bearer, a secondary cell group bearer with forwarding via X2, or split bearer.

36. The apparatus of claim 35, wherein the forwarding via X2 comprises general packet radio service tunneling protocol forwarding.

37. The apparatus of claim 35, wherein the secondary cell group bearer is configured with two tunnel endpoints, one for the master access node and another for a serving gateway.

38. The apparatus of claim 34, when exchanging the cache capability, the at least one memory and the computer program code are configured to, with the at least one processor, cause the apparatus to receive the cache capability as a static parameter.

39. The apparatus of claim 34, wherein the cache capability is received via a common X2 interface message.

40. The apparatus of claim 34, when exchanging the cache content information, the at least one memory and the computer program code are configured to, with the at least one processor, cause the apparatus to receive dynamic status information.

41. The apparatus of claim 34, wherein the cache content information is received via a user equipment specific message, an X2 message or a flow control message.

42. The apparatus of claim 41, wherein the user equipment specific message comprises a secondary evolved node B addition message, or a secondary evolved node B modification message, or a secondary evolved node B release message, or any other user equipment message.

43. A method, comprising:
exchanging, at a secondary access node, a cache capability with a master access node;
determining cache content information of the secondary access node; and
exchanging the cache content information with the master access node.

44. The method of claim 43, further comprising:
receiving a packet from a user equipment;
analyzing the packet; and
selecting between forwarding the packet to the master access node and directly communicating the packet to a serving gateway based on the analysis.
